(19) United States
(12) Patent Application Publication
(10) Pub. No.: US 2012/0012262 A1
(43) Pub. Date: Jan. 19, 2012

(54) WINDOW SHADE ASSEMBLY WITH RE-CHANNELING SYSTEM, TWO-PART SIDE CHANNELS AND SINGLE SEAL STRIP OF WRAPPING MATERIAL

(75) Inventors: Corina Santoro, Delmar, NY (US); Richard D. Watkins, Lake Luzerne, NY (US); John A. Corey, Melrose, NY (US)

(73) Assignee: COMFORTEX CORPORATION, Watervliet, NY (US)

(21) Appl. No.: 13/104,543

(22) Filed: May 10, 2011

Related U.S. Application Data
(63) Continuation-in-part of application No. 12/835,147, filed on Jul. 13, 2010.

(51) Int. Cl. E06B 9/42; E06B 9/44

(52) U.S. Cl. 160/272; 160/271

(57) ABSTRACT

A window shade assembly includes a flexible shade material having a pair of non-beaded vertical edges positioned in a pair of opposed vertical side channels. A re-channeling system includes a lip to at least partially define a plane of the flexible shade material within the side channels, and a bottom rail irremovably and slidingly received in each side channel. The side channels can be two parts. A single resilient seal strip is used with the side channels to seal the flexible shade material. The seal strip can be an edge of the flexible wrapping material for the side channels.

This application claims priority to, and is a continuation in part application of, U.S. patent application Ser. No. 12/835,147, filed on Jul. 13, 2010, entitled WINDOW SHADE ASSEMBLY WITH RE-CHANNELING SYSTEM AND SINGLE SEAL STRIP OF WRAPPING MATERIAL, the contents of which are hereby incorporated by reference.

### BACKGROUND

1. Technical Field

The invention relates generally to window shades, and more particularly, to a window shade assembly having a re-channeling system for a flexible shade material with non-beaded edges, two-part side channels and a single seal strip that may include an edge of flexible wrapping material used on the side channels.

2. Background Art

One of the older forms of window shading includes a roller shade, in which a flat, rectangular piece of material (typically fabric or film) is stored in rolled form on a substantially cylindrical roller core at the top edge of a window and unrolled when desired to cover the window to block a view or modulate light. These window shades are inexpensive to manufacture and can utilize a wide range of shade materials, some of which can be decorated with images or be made environmentally responsive, e.g., with self-darkening films. Spring-loaded and ratcheted roller cores are common because they eliminate the need for any visible actuating mechanism or the safety concerns of exposed cords. Corded clutch drives are also popular.

One drawback of typical roller shades is that they do not provide any significant thermal benefit, and only partial light control. These limitations derive from two causes: the thin, single-layer nature of rollable fabrics and films, and the open gaps at the sides (and also often at the top and bottom) between the shade material and the window aperture. In order to address the thermal issue, a number of solutions have been pursued. One approach was the development of double-depth cellular window shades that provide an insulating quality to the shade material. Despite their added thermal characteristics, however, edge gaps that allow free air movement around the shading material limit the thermal and light-blocking effectiveness of these window shades.

Another approach to provide both improved thermal and light control characteristics was to add opposing C-channels that are coupled to the window frame and slidingly engage edges of the shade material. In such systems, the shade material's edge is typically beaded (increasing its thickness along the edges) and the bead is retained in a closed C-shaped channel mounted to the window frame. The beading keeps the otherwise flaccid shade material constrained to be held taut and flat between the tracks, and creates a contact seal along that junction. Unfortunately, such beading makes the shade material roll up poorly as the thick beading controls the roll-up, instead of the flat area of the main material portion (unless that main portion is similarly thickened, as for instance by quilting, to a dimension not less than the bead thickness). Consequently, the roll is much larger for the same deployed length (called the “drop”) and the beads, being narrow, tend to fall in a disorderly way when rolling, causing wrinkles and uneven deployment. A “re-railer” for guiding a beaded-edge shade back into the C-channel if it is dislodged has also been developed. However, known re-railers are bulky and do not operate without an edge bead present, to be pulled back into the channel.

Another disadvantage to known C-channel tracks is that they are visually obtrusive and present a high level of drag to deployment that makes simple gravity-driven systems unreliable. The large roll and tracks, limited fabric options (typically thick quilts, tolerant of edge beading and subsequent wrinkling) and operational limitations of such bead-and-C systems have limited their acceptance in the market to a very narrow segment that values energy savings highly over other functions or appearance.

Some C-channel systems have been applied to non-beaded shade material. In these systems, however, where the edges of the shade material dislodges from the C-channels, re-channeling is extremely difficult, so these channels are typically made with a very deep engagement to minimize the risk of dislodging. In addition, like the beaded versions, these C-channels are visually obtrusive, may occupy a large part of the window area and present a high level of drag to deployment that makes gravity-driven systems unreliable.

### BRIEF SUMMARY

A first aspect of the invention provides a window shade assembly comprising: a headrail including a roller core wrapped with a flexible shade material having a pair of non-beaded vertical edges; a pair of opposed vertical side channels open in a direction facing one another and configured to be mounted to a surrounding frame, each side channel receiving a respective non-beaded vertical edge of the flexible shade material; a lip positioned at a vertical distance from an outer surface of the roller core to at least partially define a plane of the flexible shade material within the side channels; and a bottom rail coupled to a free edge of the flexible shade material and slidingly received in each side channel, the bottom rail including an end member at each end thereof to prevent removal from the side channels, whereby in response to at least one of the non-beaded vertical edges being at least partially removed from a side channel, the lip and bottom rail position the flexible shade material for re-channeling into the side channels upon rolling of the flexible shade material onto the roller core.

A second aspect of the invention provides a window shade assembly comprising: a headrail including a roller core wrapped with a flexible shade material having a pair of non-beaded vertical edges; a pair of opposed vertical side channels open in a direction facing one another and configured to be mounted to a surrounding frame, each side channel receiving a respective non-beaded vertical edge of the flexible shade material; and a single resilient seal strip sealingly pressing one side of a respective non-beaded vertical edge against an opposing face of the side channel.

A third aspect of the invention provides a window shade assembly comprising: a headrail including a roller core wrapped with a flexible shade material having a pair of non-beaded vertical edges; a pair of opposed vertical side channels open in a direction facing one another and configured to be mounted to a surrounding frame, each side channel receiving a respective non-beaded vertical edge of the flexible shade material; and wherein an edge of a wrapping material covering a front portion of a respective side channel enters the side channel and sealingly presses one side of a respective non-beaded vertical edge against an opposing face of the side channel.

A fourth aspect of the invention provides a window shade assembly comprising: a headrail including a roller core wrapped with a flexible shade material having a pair of non-beaded vertical edges; a pair of opposed vertical side channels open in a direction facing one another and configured to be mounted to a surrounding frame, each side channel receiving a respective non-beaded vertical edge of the flexible shade material; and wherein each side channel includes a first mount portion coupled to the surrounding frame and providing a portion of the side channel, and a second cover portion positioned relative to the first mount portion completing the side channel.

A fifth aspect of the invention provides a window shade assembly comprising: a headrail including a roller core wrapped with a flexible shade material having a pair of non-beaded vertical edges; a pair of opposed vertical side channels open in a direction facing one another and configured to be mounted to a surrounding frame, each side channel receiving a respective non-beaded vertical edge of the flexible shade material; and wherein each side channel includes an outer channel portion coupled to the surrounding frame, and an inner channel portion coupled to the outer channel portion, and the inner channel portion configured to receive the non-beaded vertical edge of the flexible shade material.

The illustrative aspects of the present invention are designed to solve the problems herein described and/or other problems not discussed.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a partial cross-sectional view in a horizontal plane through a window shade assembly according to embodiments of the invention.

FIGS. 2A-2B show vertical cross-sectional views in a vertical plane through a window shade assembly according to embodiments of the invention.

FIG. 3 shows a perspective detail view of a roller core and side channel junction.

FIG. 4 shows a front perspective view of a window shade assembly.

FIG. 5 shows a front perspective detail view of a side channel, lip and headrail junction of the window shade assembly.

FIG. 6 shows a partial cross-sectional view of a bottom rail and side channel junction.

FIG. 7 shows a cross-sectional view of an alternative embodiment of a flexible shade material for a window shade assembly according to embodiments of the invention.

FIG. 8 shows a horizontal cross-sectional view of an alternative embodiment of a side channel, including the outer channel portion and the inner channel portion, for the window shade assembly.

FIG. 9 shows a horizontal cross-sectional view of a further alternative embodiment of an inner channel portion of the side channel, for the window shade assembly of FIG. 8.

FIG. 10 shows a horizontal cross-sectional view of a further alternative embodiment of an outer channel portion of the side channel, for the window shade assembly of FIG. 8.

FIG. 11 shows a horizontal cross-sectional view of a further alternative embodiment of a side channel, including the outer channel portion and the inner channel portion, for the window shade assembly.

FIG. 12 shows a horizontal cross-sectional view of another alternative embodiment of a side channel, including the outer channel portion and the inner channel portion, for the window shade assembly.

FIG. 13 shows a vertical cross-sectional detail view of an alternative embodiment for the side channels according to FIGS. 8-10.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, embodiments of the invention provide a window shade assembly that acts as an effective and active insulating and light-blocking member on a window, with the aesthetic benefits (including image display on a flat surface when deployed) and the ease of installation and operation of a conventional roller shade. As used herein, the term “window” may include any ventilation and/or light emitting opening in a structure of any kind.

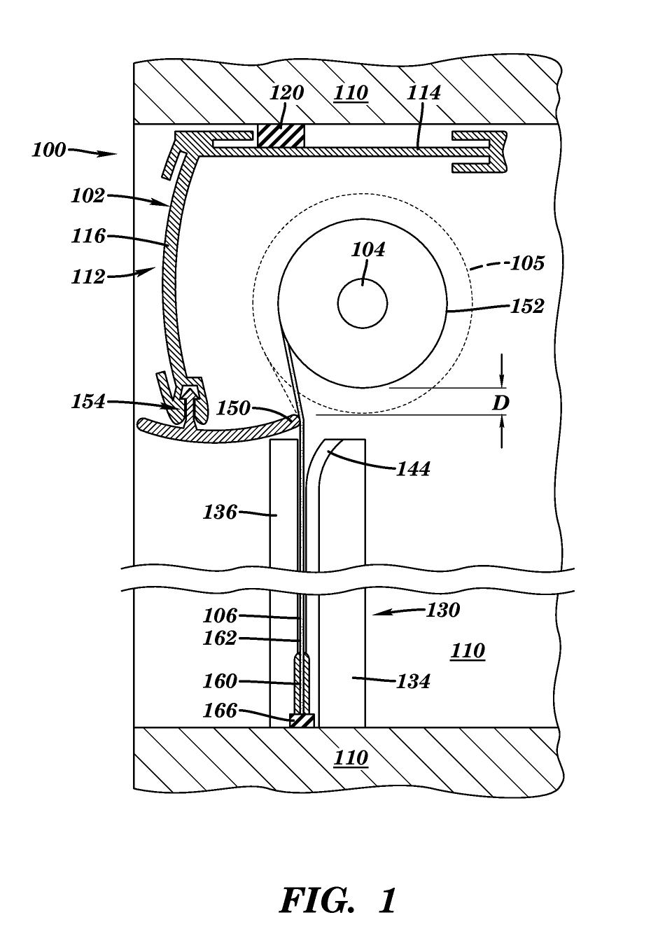

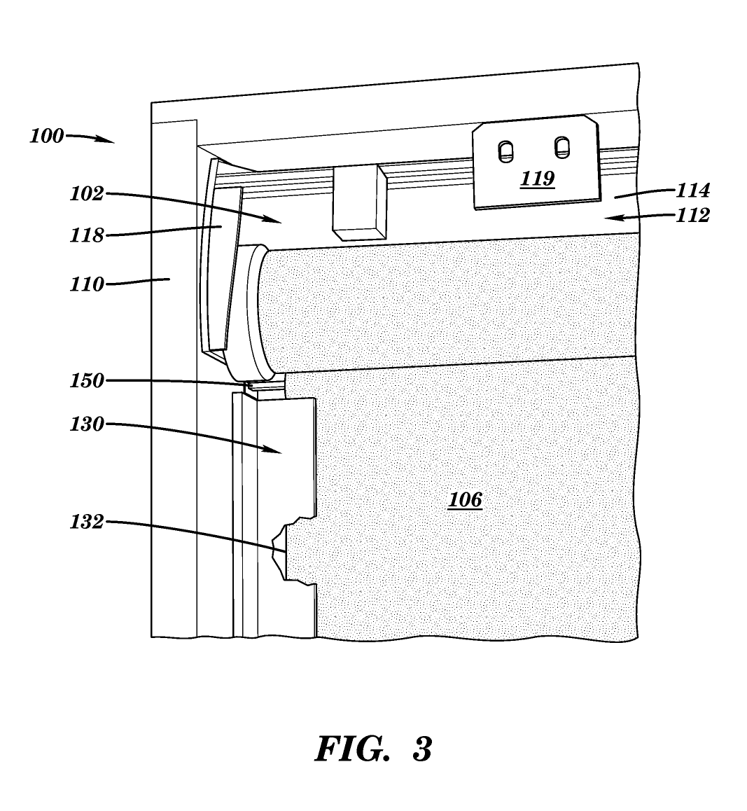

Referring to FIG. 1, a partial cross-sectional view in a vertical plane through a window shade assembly 100 according to embodiments of the invention is provided. Window shade assembly 100 includes a headrail 102 including a roller core 104 wrapped with a flexible shade material 106. Headrail 102 may include any frame structure of hard material such as plastic or metal for mounting window shade assembly 100 to a surrounding frame 110 that defines the window for which window shade assembly 100 is to be used. As illustrated in FIGS. 1 and 3, in one embodiment, headrail 102 includes a substantially L-shaped member 112 having a first leg 114, and a downwardly extending face portion 116 that covers the mechanics of window shade assembly 100, e.g., roller core 104 and structure for moving roller core 104 such as a spring load or ratchet mechanisms, corded clutch drives, etc. (not shown) as known in the art. As known in the art, face portion 116 may be covered by a wrapping material (not shown) that matches or complements flexible shade material 106, e.g., using adhesive or grooves.

Roller core 104, shown best in FIG. 1, may include any rod-like structure capable of having flexible shade material 106 wrapped thereupon, e.g., a plastic, cardboard, wood dowel or tube. A maximum accumulation of flexible shade material 106 on roller core 104 is shown by dashed circle 105. Flexible shade material 106 may include any now known or later developed shade material such as but not limited to woven cloth (with or without polymer coatings), plastics, etc.

As shown in FIG. 3, headrail 102 may also include a pair of end plates 118 (only one shown) at opposing ends thereof. Headrail 102 may be permanently coupled to surrounding frame 110 by any now known or later developed mounting mechanism, e.g., screws, adhesives, brackets (119 in FIG. 3) or any other type of permanent mounting structure. As shown in FIG. 1, resilient gasket 120 may be employed on the top and/or sides of headrail 102 to provide a seal against heat and/or cold passage, or light passage. Resilient gasket 120 may include any now known or later developed pliant material such as a polymer, fiber pile, etc. Although a particular headrail 102 has been described herein, it is understood that the teachings of the invention are not limited to this type of headrail.

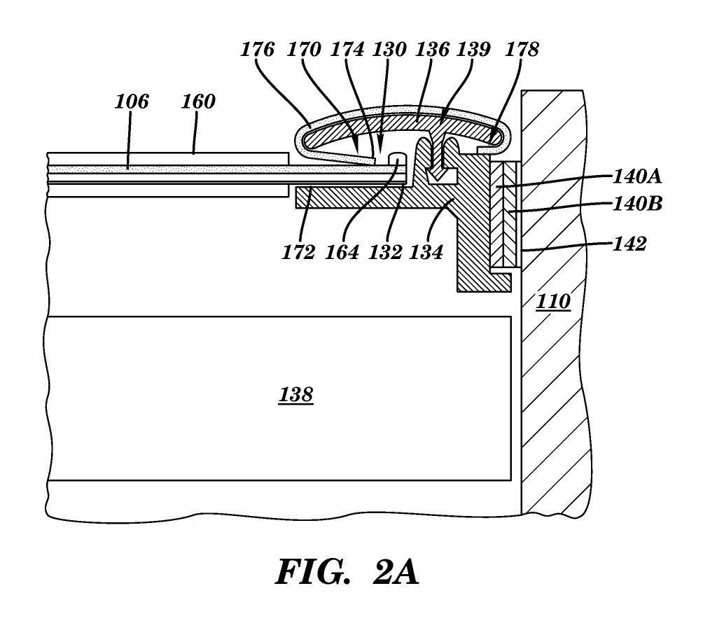

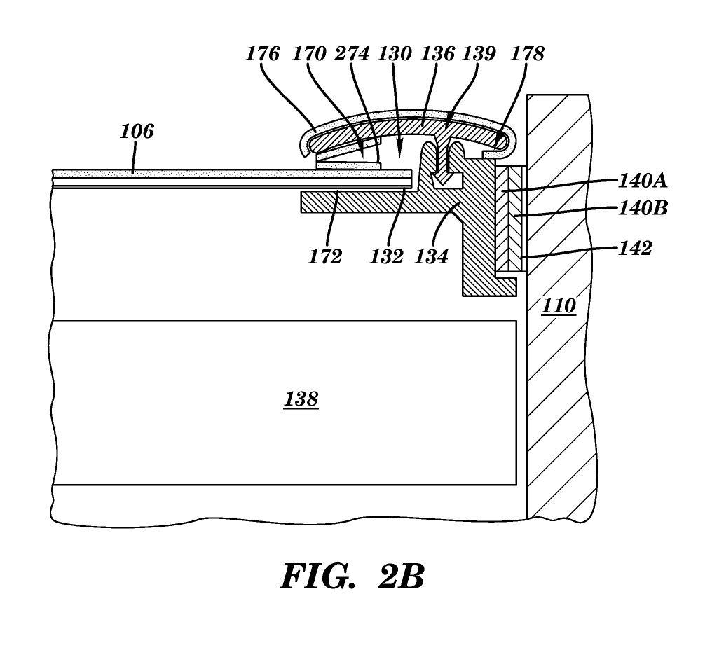

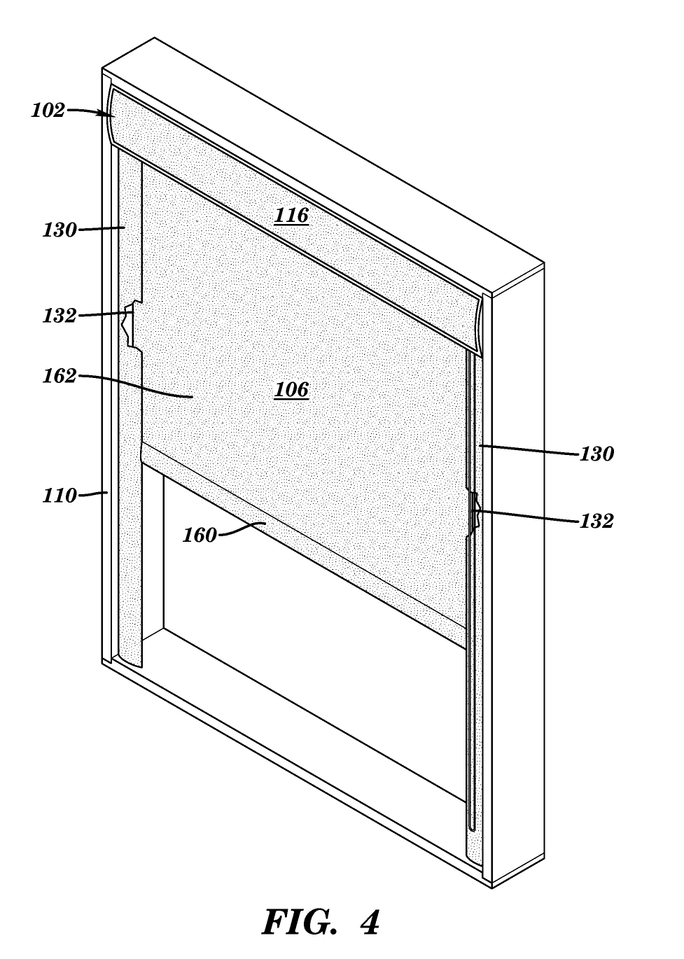

Window shade assembly 100 also includes a pair of opposed vertical side channels 130 open in a direction facing one another and configured to be mounted to surrounding frame 110. As shown best in FIGS. 2A, 2B, 3 and 4, flexible shade material 106 includes a pair of non-beaded vertical edges 132 on opposing sides thereof. Each side channel 130 receives a respective non-beaded vertical edge 132 of flexible shade material 106 such that flexible shade material 106 can lie within side channels 130 without substantial deflection from its free-hanging position (in the absence of the channels). As used herein, “non-beaded” indicates edge 132 does not have a greater thickness than the shade material 106 in a direction perpendicular to a plane of flexible shade material 106 that would prevent removal from side channels 130. Consequently, an advantage that may be realized in the practice of some embodiments of the described window shade assembly 100 is that they do not require any modification of flexible shade material edges 132, preserving uniform and compact roll-up.

In one embodiment, as shown best in FIGS. 2A-2B, in contrast to conventional window shade systems, each side channel 130 includes two parts: a first mount portion 134 and a second cover portion 136. First mount portion 134 may be coupled to surrounding frame 110 and provides a portion of side channel 130, i.e., the back portion of a side channel 130 as illustrated. Second cover portion 136 is positioned relative to first mount portion 134 to complete side channel 130. Second cover portion 136 may be positioned relative to first mount portion 134 in a number of ways. In one embodiment, second mount portion 136 may be releasably coupled to first mount portion 134. In the example shown, second cover portion 136 is coupled to first mount portion 134 using a snap fit connection 139 including, for example, a barb on one portion and a mating cavity on the other portion. Other examples may include hook-and-latch fasteners, screws, adhesive, etc. In an alternative embodiment, not shown, second mount portion 136 could also be coupled to surrounding frame 110 in a known fashion, e.g., using fasteners such as screws or adhesive, to position it relative to first mount portion 134. An advantage that may be realized in the practice of some embodiments of the described window shade assembly 100 using portions 134, 136 is that it enables assembly by positioning a wrapping material 176 (e.g., fabric) over second cover portion 136 without having to tuck it in all along side channel 130. Also, it allows interchangeable wrapping material 176 for multiple appearance options, and allows the forming of side channel 130 with an outer depth closer to surrounding frame 110 that is greater than an inner depth closer to a center of window shade assembly 100. Consequently, flexible shade material 106 can pass entries of side channels 130, which prevents the fabric from flapping, and enters a wider internal cavity, where an edge 174 of wrapped material 176 seals. A narrow-maw, large-core cavity is difficult to extrude in one piece.

In one embodiment, first mount portion 134 is permanently coupled to surrounding frame 110 in a known fashion, e.g., using screws or adhesive or any other now known or later developed fixing structure. In an alternative embodiment, however, as shown in FIGS. 2A-2B, first mount portion 134 is removably mounted to surrounding frame 110 by, for example, mating magnet strips 140A, 140B (as described herein), hook-and-loop fasteners or other means known in the art for removable attachments. An advantage that may be realized in the practice of some embodiments of the described window shade assembly 100 using the removable mounting of first mount portion 134 is that it allows, for example, unobstructed tilting of a window sash 138 through surrounding frame 110 (where that feature is provided) when each vertical side channel 130 is removed. In one embodiment, each vertical side channel 130, i.e., first mount portion 134, is removably mounted to surrounding frame 110 by a pair of separable magnetic strips 140A, 140B. In this case, one magnetic strip 140A may be coupled to vertical side channel 130, i.e., first mount portion 134, and the other magnetic strip 140B may be coupled to surrounding frame 110. Magnetic strip 140A may be permanently, for example, adhesively, coupled to first mount portion 134 during manufacture, while magnetic strip 140B may be provided with an adhesive 142 with a peel-off layer (not shown) such that an installer can peel off the peel-off layer, adhere magnetic strip 140B to surrounding frame 110 and then magnetically couple magnetic strips 140A, 140B to position first mount portion 134. In this fashion, when window sash 138 must be accessed, e.g., for cleaning or repair, side channels 130 can be easily removed, leaving a very narrow and unobtrusive magnetic strip 140B. Consequently, sash 138 can be easily accessed, and can even tilt in where that feature is provided. When complete, first mount portion 134 and, hence, side channel 130 can be easily and accurately re-installed by re-engaging magnetic strips 140A, 140B. The process can be repeated frequently without difficulty or damage. An upper end of each side channel 130 may include a flared open end 144 (FIG. 1) through which flexible shade material 106 extends. Flared open end 144 may be created in a number of ways such as having first mount portion 134 have a curved end, as shown in FIG. 1.

In another embodiment, as shown best in FIG. 1, window shade assembly 100 includes a re-channeling system (not numbered) capable of simply and efficiently returning one or more of non-beaded vertical edges 132 to side channel(s) 130 when removed from the side channel(s). Non-beaded vertical edges 132 may be removed from side channel(s) 130 in a number of ways such as accidental application of a force perpendicular to the plane of flexible shade material 106. Re-channeling system is provided, in part, by a lip 150 positioned at a vertical distance D from an outer surface 152 of roller core 104. Vertical distance D allows all of flexible shade material 106 not over bottom rail 160 to pass ends of first mount portion 134 and second cover portion 136 and be re-positioned within side channels 130, i.e., re-channeled. Lip 150 at least partially defines a plane of flexible shade material 106 within side channels 130. That is, lip 150 spans a width (perhaps intermittently) of exposed flexible shade material 106 between side channels 130, and positions flexible shade material 106 in a substantially vertical plane that coincides with side channels 130—between first mount portion 134 and second cover portion 136. Lip 150 is also positioned horizontally such that its edge that engages flexible shade material 106 always engages flexible shade material 106 to define the above-described plane regardless of the material's tangent point with roller core 104, which may change with differing amounts of flexible shade material 106 collected on roller core 104. Note, while FIG. 1 shows an overhand unroll (as viewed from the interior), window shade assembly 100 can be made with an underhand roll also. In this case, lip 150 may be longer to properly engage flexible shade material 106. In one embodiment, lip 150 is mounted to headrail 102 by a coupling 154, which may be made in a number of ways. In one embodiment, coupling 154 includes a snap fit connection including, for example, a barb on the headrail or the lip and a mating cavity on the other of headrail and lip. Other examples may include screws, adhesive, etc. However, as shown in FIG. 3, coupling of lip 150 to headrail 102 may not be necessary in all cases, as lip 150 may provide the same positioning when mounted to surrounding frame 110, e.g. via screws or other known fasteners. An advantage that may be realized in the practice of some embodiments of the described assembly, as can be observed by comparing FIGS. 1 and 2, is that second cover portion 136 and lip 150 may have a substantially identical cross-sectional shape, which may assist in reducing manufacturing costs. Second cover portion 136 and lip 150 may include, for example, extruded plastic.

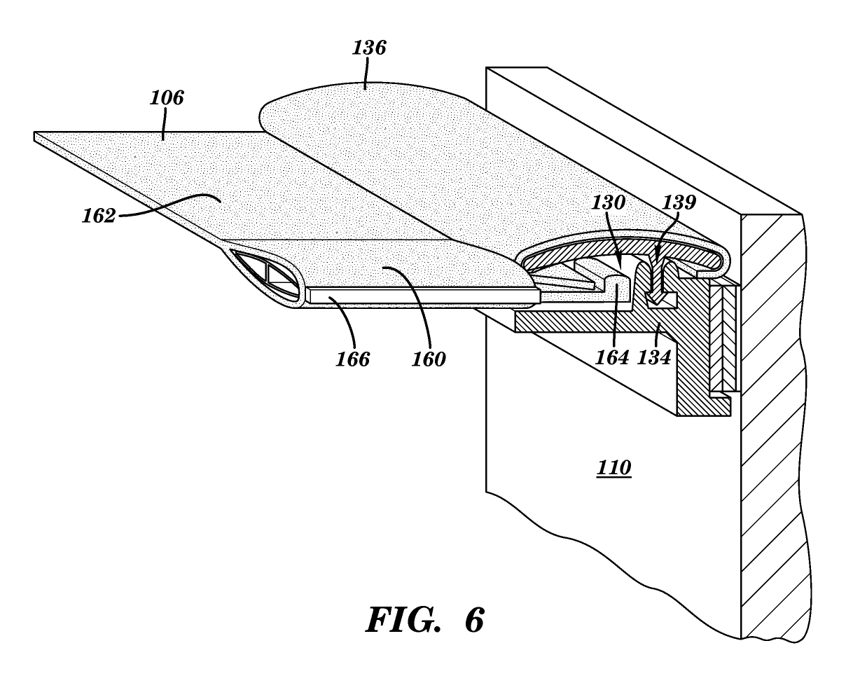

As shown best in FIGS. 2A and 6, the re-channeling system also may include a bottom rail 160 coupled to a free edge 162 of flexible shade material 106. Bottom rail 160 is slidingly received in each side channel 130 and provides weight and stiffness to free edge 162 to assist in lowering flexible shade material 106. In addition, bottom rail 160 may include an end member 164 at each end thereof to prevent removal from side channels 130 and provide lateral location. That is, end members 164 provide a thickness sized to fit freely within side channels 130, but with flexible shade material 106 extending to its full width at either end of bottom rail 160 and engaging with side channels 130 there. As noted above, and as shown best in FIG. 2A, side channels 130 may have an outer depth closer to surrounding frame 110 that is greater than an inner depth closer to a center of window shade assembly 100 such that end member 164 can pass entries of side channels 130, but cannot be pulled out through the narrower entry. Consequently, while non-beaded vertical edges 132 along flexible shade material 106 may be removed from side channels 130, bottom rail 160 is provided with increased resistance to dislodging and is substantially irremovable (except from ends of side channels 130, as when the side channels themselves are removed from surrounding frame 110). End members 164 may be provided in any number of ways. For example, end members 164 may include a compressed or shaped widened portion of bottom rail 160, an extension of bottom rail 160 having a widened portion or a wider insert into bottom rail 160, each of which can be wrapped with flexible shade material 106. End members 164 may be integral with bottom rail 160 or separate therefrom. Bottom rail 160 may also include a resilient gasket 166 to provide a seal against heat and/or cold passage, or light passage, when abutting surrounding frame 110, e.g., at a sill of a window. Resilient gasket 166 may include any now known or later developed pliant material such as a polymer, fiber pile, etc. Operation of re-channeling system will be described elsewhere herein.

Referring to FIGS. 2A-2B, window shade assembly 100 may also include a single resilient seal strip 170 sealingly pressing one side of a respective non-beaded vertical edge 132 against an opposing face 172 of side channel 130. As illustrated, opposing face 172 is provided by first mount portion 134; however, this may not be necessary in all cases. The use of a single resilient seal strip 170 is in contrast to conventional systems that typically use two strips (one on each side of material 106), which provide increased drag on flexible shade material 106 and may prevent gravity-feed implementation. The shape of side channel 130 with a narrower slot over flexible shade material 106 and a wider cavity (enabled in part by portions 134, 136) also reduces drag and allows for a larger travel (without an unduly wide slot that would allow flapping, leakage, and easier pull-out). Consequently, resilient seal strip 170 can have a lower spring force and lower drag without sacrificing sealing. As shown in FIG. 2A, in one embodiment, single resilient seal strip 170 may include an edge 174 of a wrapping material 176 covering a front portion of a respective side channel 130, i.e., second cover portion 136. Edge 174 is un-adhered to and wraps around second cover portion 136 to enter side channel 130 and engage non-beaded vertical edge 132. Edge 174 creates a barrier to air passage but does not create excessive drag on flexible shade material 106 as it moves (into and out of page in FIG. 2A). The amount of pressure applied by edge 174 can be controlled, for example, based on the material used, the shape of second mount portion 136, the amount of bend initially created in wrapping material 176, etc. In an alternative embodiment, shown in FIG. 2B, single resilient seal strip 170 may be provided by a V-strip 274 of, for example, plastic, which provides a similar pressure as edge 174 (FIG. 2A). Other options for providing a single resilient seal strip 170 may also be possible and are considered within the scope of the invention.

Wrapping material 176 may be coupled to second cover portion 136 in any now known or later developed fashion, e.g., adhesive, friction fit into a groove, etc. In one embodiment, however, as shown in FIGS. 2A-2B, wrapping material 176 may be held in place at least in part by engagement of first mount portion 134 and second cover portion 136, e.g., at a point 178. Adhesive between second cover portion 136 and wrapping material 176 may also be employed with this engagement. Wrapping material 176 may include a pattern thereon substantially similar to a pattern on flexible shade material 106, i.e., same pattern or an aesthetically complementary pattern.

In operation, window shade assembly 100 according to embodiments of the invention is usually operated in a manner similar to conventional roller shades, e.g., using loop cord actuators or spring loaded actuators. In one example, a loop cord actuator (not shown) is provided that rotates roller core 104 through a clutch (not shown) that holds roller core 104 in position when the loop cord is not moved. (As the structure of loop cord actuators and clutches are well known in the art, no further description is provided.) Gravity pulls downward on bottom rail 160 and flexible shade material 106, causing it to hang tautly and to drop freely, so long as friction forces between flexible shade material 106 and resilient seal strip 170 do not exceed the weight force. Use of common flexible shade materials such as woven cloth, with or without flexible polymer coatings, and known to those skilled in the art, when used for resilient seal strip 170 together with the same material in shade material have been shown to meet this freely dropping requirement. Raising the shade does not depend so much on gravity or a force balance, as flexible shade material 106 is pulled upward and accumulated onto roller core 104 by rotating in the opposite direction.

The re-channeling system according to embodiments of the invention provides a recovery mode of operation that is used when at least one of non-beaded vertical edges 132 is at least partially removed from a side channel 130. That is, edge(s) 132 of flexible shade material 106 may be displaced from their intended position within side channels 130 for a number of reasons such as but not limited to: an accidental hand, household pet or strong gust of wind pressing on the face of flexible shade material 106, bowing it and drawing in edges 132 until they are released from side channels 130. In this case, in contrast to conventional systems, no cumbersome manual re-insertion is required. Instead, as shown in dashed lines in FIG. 1, because bottom rail 160 remains engaged in side channels 130 and with it a portion of flexible shade material 106, raising the shade will draw all of the displaced flexible shade material 106 onto roller core 104, above the ends of side channels 130. In addition, lip 150 (and the ends of side channels 130) is positioned at distance D from roller core 104 to position flexible shade material 106 for re-channeling into side channels 130 upon rolling of flexible shade material 106 onto roller core 104. Consequently, lowering the shade again causes flexible shade material 106 to follow bottom rail 160 and descend again within side channels 130.

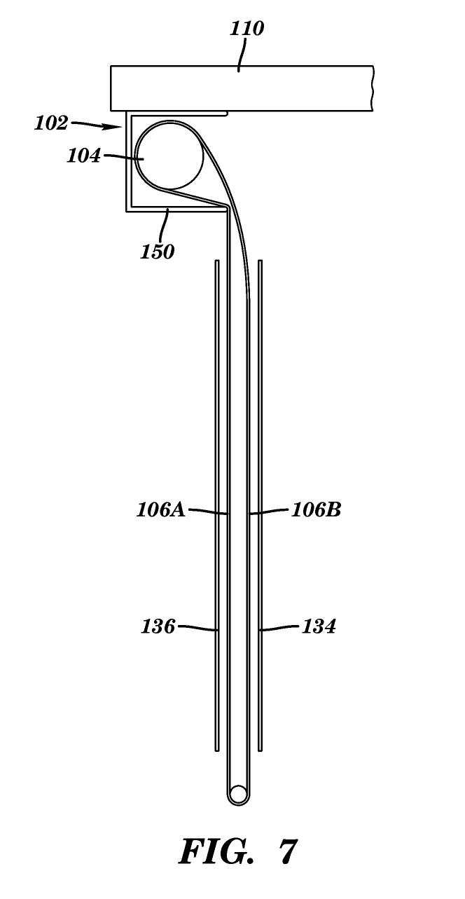

In an alternative embodiment, as shown in FIG. 7, flexible shade material 106 may include a plurality of flexible layers 106A, 106B having adjustable reveal openings therein such as described in U.S. Pat. No. 6,651,720 to DiSilvestro et al. or U.S. Pat. No. 6,189,592 to Domel. Embodiments of the invention as described herein may be used for the flexible shade material, retaining the features of those inventions of providing adjustable visibility through the deployed shade (i.e., when unrolled and covering the window) by relative vertical movement of the plurality of layers controlled by incremental rotation of the roller core. In such an embodiment, provision is made at the bottom rail to contain the bight of Domel or the two weighted rails of DiSilvestro, without otherwise affecting the operation or components of embodiments of the present invention.

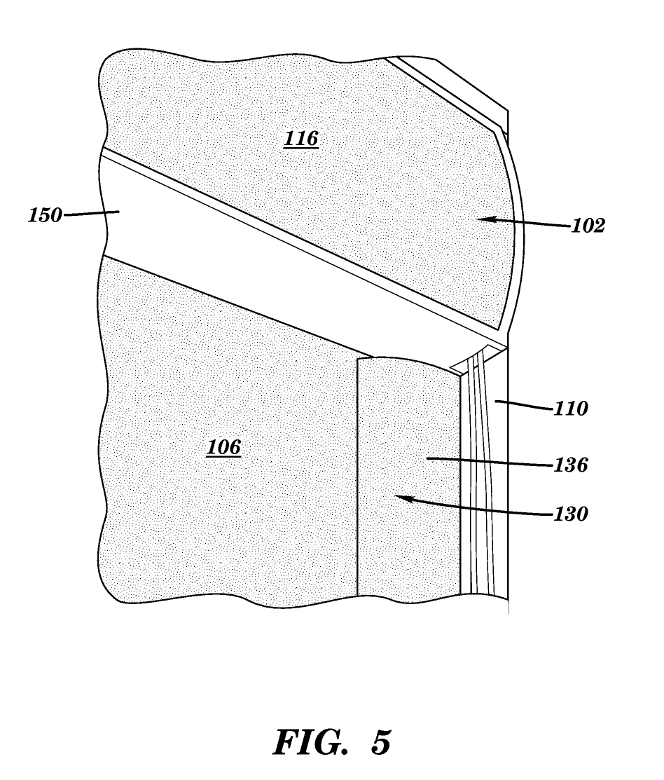

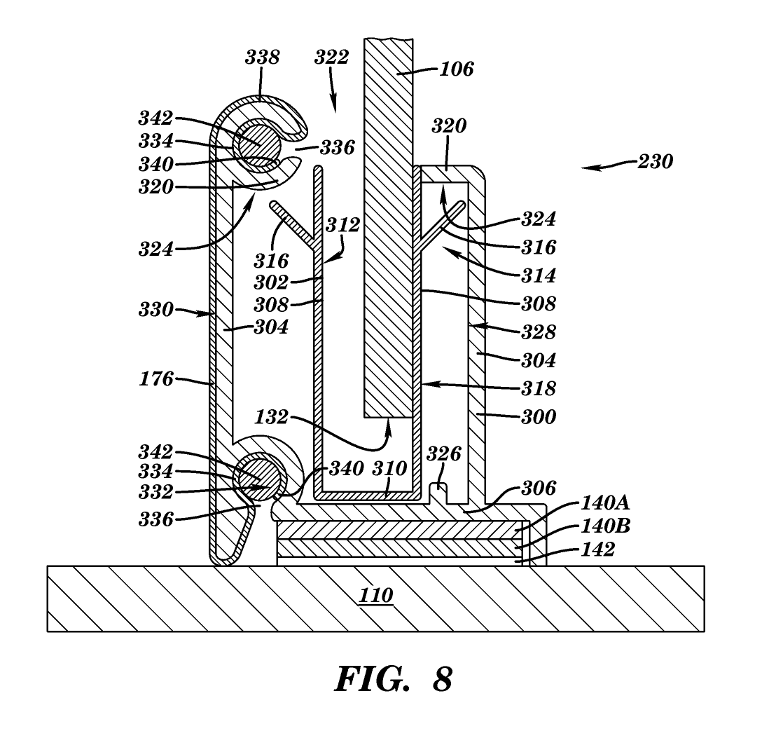

In another embodiment, as best shown in FIG. 8, a horizontal cross-sectional view of a side channel 230 for window shade assembly 100 (FIG. 1) is shown according to an embodiment of the invention. Window shade assembly 100 that includes side channel 230 of FIG. 8 incorporates substantially similar components (e.g. headrail 102, roller core 104, surrounding frame 110, etc.) as shown and described with reference to FIGS. 1-6. It is understood that these similarly numbered components may function in a substantially similar fashion as described with reference to the other Figures herein. Redundant explanation of these elements has been omitted for clarity.

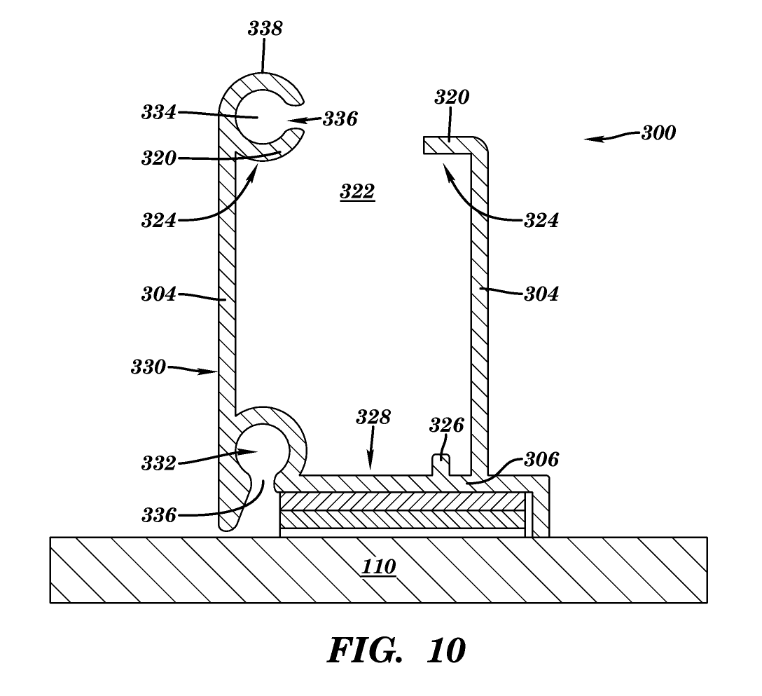

As shown in FIG. 8, side channel 230 may include an outer channel portion 300 and an inner channel portion 302, coupled to outer channel portion 300. More specifically, as shown in FIG. 8, inner channel portion 302 may be configured within outer channel portion 300. In one example embodiment, as best shown in FIGS. 8 and 10, outer channel portion 300 may be configured as two substantially parallel outer channel members 304 connected by a single outer channel base 306. Outer channel members 304 may be substantially perpendicular to surrounding frame 110 and outer channel base 306 may be substantially parallel to surrounding frame 110. It is understood that outer channel members 304 may also be angled other than at 90 degree angles. Inner channel portion 302 may be configured as two substantially parallel inner channel walls 308 connected by an inner channel base 310. Substantially parallel inner channel walls 308 may be substantially perpendicular to surrounding frame 110 and outer channel base 306, respectively Inner channel walls 308 may also be substantially parallel with outer channel members 304. Inner channel base 310 may be configured to be substantially parallel to surrounding frame 110 and outer channel base 306, respectively. It is understood that inner channel walls 308 may also be angled other than at 90 degree angles. Outer channel portion 300 and inner channel portion 302 may be comprised of any combination of material providing a substantially rigid structure, e.g., plastic, metal, wood, or any other now known or later developed material or combination of material.

Side channel 230 may be coupled to surrounding frame 110 (FIG. 1) in a number of ways. In one example embodiment, as best shown in FIG. 8, side channel 230, and more specifically outer channel portion 300, is configured to releasably couple to surrounding frame 110 using separable magnet strips 140A, 140B as described in reference to FIGS. 2A-2B. In the example embodiment as shown in FIG. 8, separable magnet 140A may be attached to outer channel base 306 of outer channel portion 300 and separable magnet 140B may be attached to surrounding frame 110 using adhesive 142. In an alternative embodiment, side channel 230 may also be coupled to surrounding frame 110 in a known fashion, e.g., fasteners such as screws, adhesive, or any other now known or later developed fixing structure.

Side channel 230 may also be configured to receive non-beaded vertical edge 132 of flexible shade material 106. In one example embodiment, as best shown in FIG. 8, inner channel portion 302 may be configured to receive non-beaded vertical edge 132 of flexible shade material 106. In the example embodiment, flexible shade material 106 is substantially sealed, airtight, against an interior surface 312 of wall 308 of inner channel portion 302. In FIG. 8, non-beaded vertical edge 132 of flexible shade material 106 is substantially enclosed within inner channel portion 302. In another embodiment of the invention an optional foam strip may press flexible shade material 106 against interior surface 312 of inner channel portion 302, for substantially preventing heat and/or cold passage, or light passage through side channel 230.

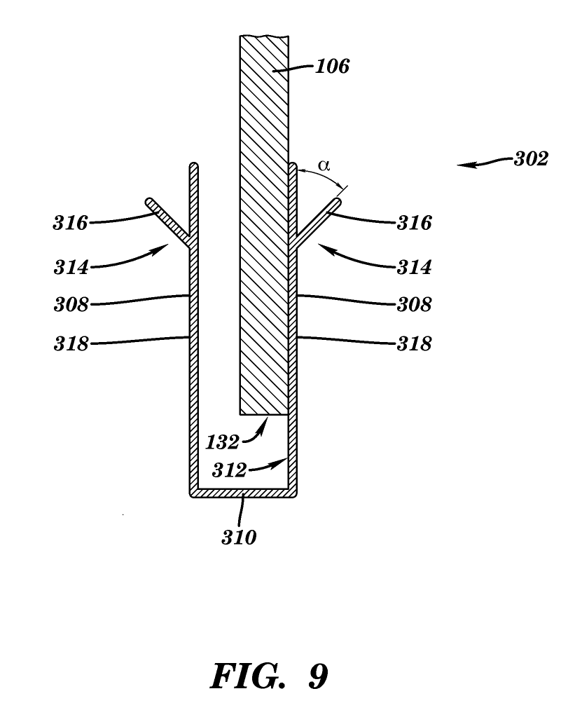

Referring to FIG. 9, inner channel portion 302 of side channel 230 may also include at least one retaining member 314 for substantially preventing inner channel portion 302 from being unintentionally removed from outer channel portion 300. In one embodiment, retaining member 314 may include at least one protrusion 316. Protrusion 316 may take a variety of forms such as, but not limited to, e.g., elongated tab, flat protrusion, extended ridge, substantially curved projection or any other later developed configuration that will prevent inner channel portion 302 from being unintentionally removed from outer channel portion 300. In an example embodiment, as best shown in FIG. 9, retaining member 314 includes a pair of protrusions 316 extending from an exterior surface 318 of inner channel portion 302 at an angle (α) relative to exterior surface 318. FIG. 9 shows angle (α) as being substantially between 5 degrees and 90 degrees relative to exterior surface 318 of inner channel portion 302. More specifically, angle (α) may be substantially 45 degrees in relation to exterior surface 318. In a further alternative embodiment, rather than a single piece, a plurality of retaining members 314 may be found on exterior surface 318 of inner channel portion 302 to further prevent the unintentional removal of inner channel portion 302 from outer channel portion 300. As best shown in FIG. 9, retaining member 314 is configured to inner channel portion 302 as an integral component with inner channel portion 302. In an alternative embodiment, retaining member 314 may be formed as a separate, attachable component to be coupled to exterior surface 318 of inner channel portion 302. In the alternative embodiment, a plurality of assorted retaining members 314 may be attached to exterior surface 318, e.g., by adhesive or other fasteners of inner channel portion 302 to prevent the unintentional removal of inner channel portion 302 from outer channel portion 300.

Referring to FIG. 10, outer channel portion 300 may include at least one flange 320 to aid in preventing the unintentional removal of inner channel portion 302 from outer channel portion 300. In an example embodiment, as best shown in FIG. 10, flange 320 may be located substantially adjacent an opening 322 of outer channel portion 300. Flange 320 may be configured in a number of ways. In one example embodiment, as shown in FIG. 10, flange 320 may be configured as a substantially flat protrusion, extending substantially parallel to surrounding frame 110. Alternatively, as shown in FIG. 10, flange 320 could be configured as a substantially convex protrusion, protruding inwardly toward inner channel portion 302. Flange 320 may also be configured as, e.g., a protrusion angled relative to the surrounding frame, a concave projection, or any other later developed configuration. In the embodiment shown in FIG. 10, flange 320 provides a catch surface 324 for substantially engaging retaining members 314 (FIGS. 8-9), which substantially prevents the removal of inner channel portion 302 from outer channel portion 300. As seen in FIG. 8, if inner channel portion 302 moves laterally (as inserted), toward opening 322 of outer channel portion 300, catch surface 324 of flange 320 substantially engages retaining member 314 of inner channel portion 302 and prevents the unintentional removal of inner channel portion 302 from outer channel portion 300.

Outer channel portion 300, as shown in FIG. 10, may also include a positioning member 326 for positioning inner channel portion 302 relative to outer channel portion 300. In one embodiment, as shown in FIG. 10, positioning member 326 may be configured as a substantially small tab protrusion positioned on an inner surface 328 of outer channel portion 300. As shown in FIG. 10, positioning member 326 may also be positioned substantially adjacent surrounding frame 110. FIG. 10 also shows positioning member 326 configured to extend substantially over a length of outer channel portion 300. However, this may not be necessary in all cases. In an alternative embodiment, positioning member 326 may be configured as, e.g., a rounded projection, a substantially angled protrusion, or any other later developed configuration for substantially positioning inner channel portion 302. In a further alternative embodiment, positioning member 326 may be positioned substantially anywhere on inner surface 328 of outer channel portion 300 for providing positioning of inner channel portion 302 within outer channel portion 300. In another alternative embodiment, inner surface 328 of outer channel portion 300 may also be provided with a plurality of positioning members 326.

Returning to FIG. 8, outer channel portion 300 of side channel 230 may have wrapping material 176 (FIG. 1) thereover, for substantially covering a front surface 330 of outer channel portion 300. Outer channel portion 300 may also include at least one engager 332 for coupling wrapping material 176 to front surface 330 of outer channel portion 300. Engagers 332 may be configured and positioned in a number of ways. In one example, as shown in FIG. 8, a pair of engagers 332 may be configured to include a recess 334, provided with an inlet 336 for receiving wrapping material 176. In the embodiment shown in FIG. 8, recess 334 may be disposed substantially adjacent front surface 330 of outer channel portion 300. In the example shown in FIG. 8, wrapping material 176 is disposed substantially over front surface 330 of outer channel portion 300 and wrapped around an outer edge 338 of outer channel portion 300 to be received by engager 332. More specifically, wrapping material 176 is inserted into recess 334, via the inlet 336, where ends 340 of wrapping material 176 may be configured within recess 334. In the embodiment shown in FIG. 8, side channel 230 may further comprise a securing rod 342 inserted into recess 334, once wrapping material 176 is positioned within recess 334, for securing and/or maintaining wrapping material 176 over front surface 330 of outer channel portion 300. Securing rod 342, provided within recess 334, allows wrapping material 176 to be held substantially taut over front surface 330 of outer channel portion 300. In FIG. 8, wrapping material 176, engager 332, recess 334 and securing rod 342 extend substantially over the vertical length of outer channel portion 300. However, this may not be necessary in all cases. In an alternative embodiment, engager 332 may be configured as, e.g., a clamp, an adhesive, a tie down, a magnet, or any other later developed configuration for substantially coupling wrapping material 176 to front surface 330 of outer channel portion 300. In a further alternative embodiment, engager 332 may also be positioned elsewhere within window shade assembly 100, including, but not limited to, directly on front surface 330. As previously stated, in reference to FIGS. 2A-2B, wrapping material 176 may include a pattern thereon substantially similar to a pattern on flexible shade material 106, i.e., same pattern or an aesthetically complementary pattern.

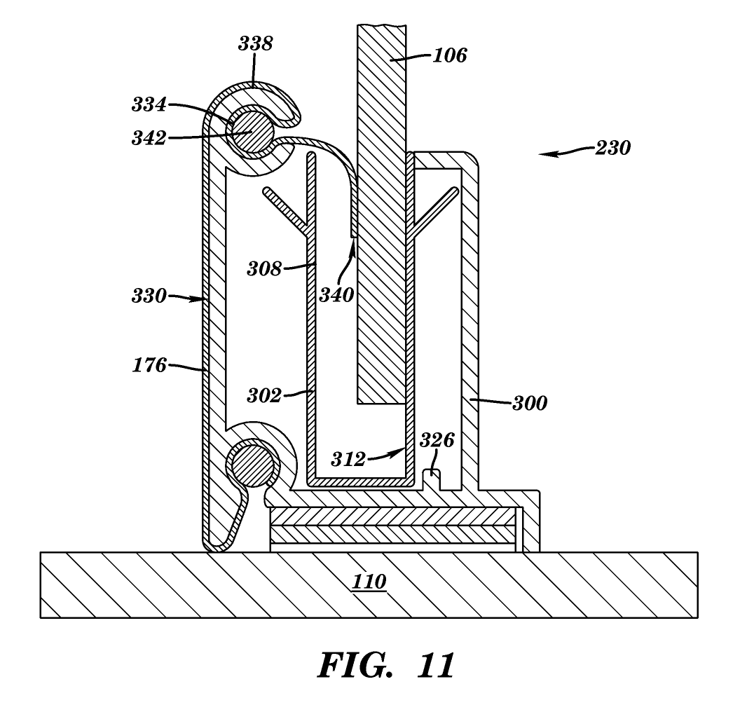

In an alternative embodiment, as shown in FIG. 11, one end 340 of wrapping material 176 may be provided substantially within inner channel portion 302. In the alternative embodiment, as shown in FIG. 11, wrapping material 176 may be wrapped around outer edge 338 of outer channel portion 300 and within recess 334 as similarly described and shown in FIG. 8, and may be disposed substantially within inner channel portion 302, whereby end 340 of wrapping material 176 is located substantially adjacent flexible shade material 106. As shown in FIG. 11, the wrapping material 176 sealingly presses flexible shade material 106 against interior surface 312 of inner channel portion 302 and substantially prevents heat and/or cold passage, or light passage through side channel 230.

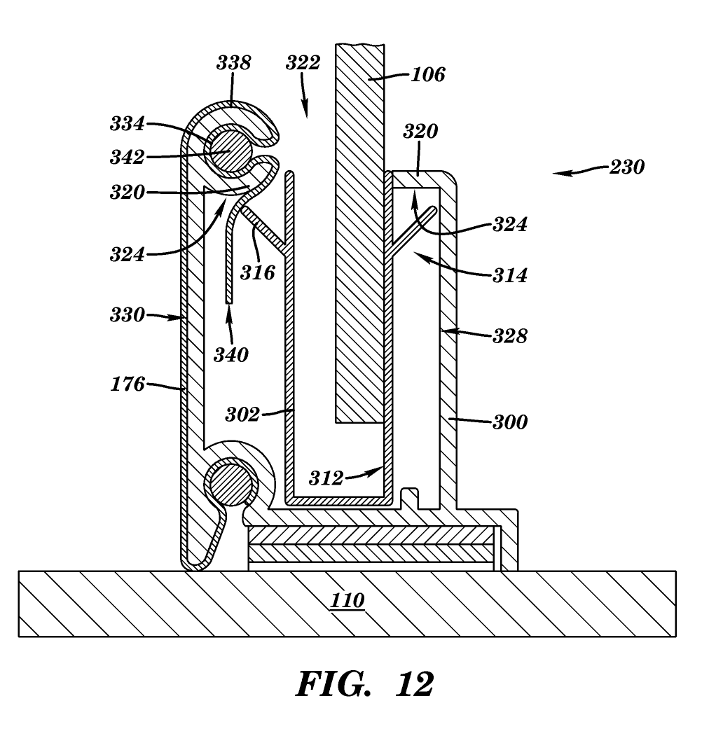

In a further alternative embodiment, as shown in FIG. 12, end 340 of wrapping material 176 may be provided substantially between outer channel portion 300 and inner channel portion 302. As shown in FIG. 12, wrapping material 176 may be wrapped around outer edge 338 of outer channel portion 300 and within recess 334 as similarly described and shown in FIG. 8, and may be positioned between outer channel portion 300 and inner channel portion 302. More specifically, wrapping material 176 may be substantially positioned between protrusion 316 of retaining member 314 of inner channel portion 302 and flange 320 of outer channel portion 300, such that end 340 is positioned substantially between outer channel portion 300 and inner channel portion 302. In the alternative embodiment, as shown in FIG. 12, protrusion 316 of retaining member 314 of inner channel portion 302 may further aid in preventing the removal of wrapping material 176 from outer channel portion 300 by substantially pressing wrapping material 176 against catch surface 324 of flange 320 of outer channel portion 300. Additionally, the alternative embodiment, as shown in FIG. 12, may provide a user with a substantially easier and substantially minimal assembly time in substantially coupling wrapping material 176 to front surface 330 of outer channel portion 300. More specifically, and in comparison to a trimmed end 340 of wrapping material 176 as shown in FIG. 8, the alternative embodiment, as shown in FIG. 12 allows a user to leave end 340 substantially untrimmed and/or substantially long by positioning end 340 substantially between channel portion 300 and inner channel portion 302. The alternative embodiment, as shown in FIG. 12, allows for substantially less precision in sizing and substantially coupling wrapping material 176 to front surface 330 of outer channel portion 300, and thus substantially reduces the time to assemble side channel 230 as described herein.

In an alternative embodiment, flange 320 and/or protrusion 316 may include a gripping component for substantially preventing the removal of wrapping material 176 from outer channel portion 300. More specifically, catch surface 324 of flange 320 and/or end of protrusion 316 may include a gripping component, such that wrapping material 176 may be substantially prevented from being removed from outer channel 300 by being substantially held in place by a gripping component. Gripping component may take a variety of forms, such as, but not limited to, a rough surface, an adhesive or any other later developed configuration that will substantially prevent removal of end 340 of wrapping material 176 from inner channel portion 302.

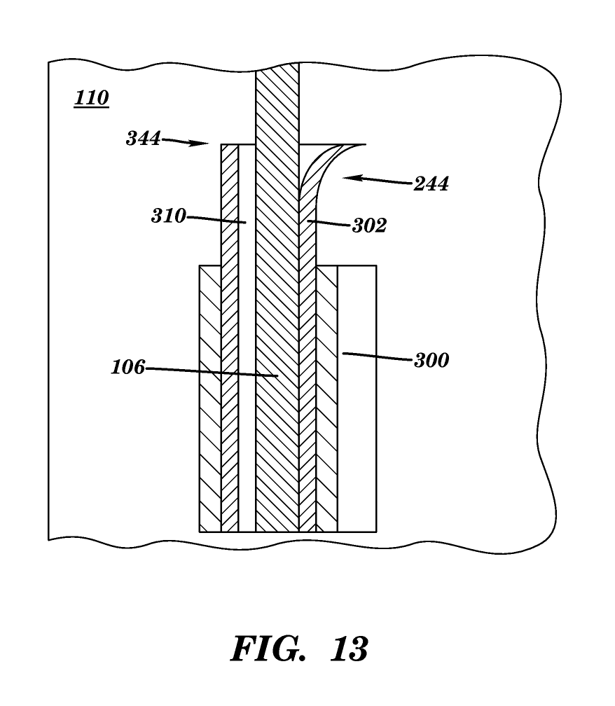

As similarly discussed in detail above in reference to FIGS. 2A, 2B, 3 and 4, and briefly discussed above in reference to FIGS. 8-12, side channel 230 receives a respective non-beaded vertical edge 132 of flexible shade material 106. Non-beaded vertical edge 132 of flexible shade material 106 may be inserted into side channel 230 by rolling flexible shade material 106 onto roller core 104, so free edge 162 (FIG. 1) may be positioned near an upper end 344 of side channels 230. Once positioned near upper end 344 of side channels 230, respective non-beaded vertical edge 132 and free edge 162 may be inserted into the respective side channel 230, prior to side channel 230 being substantially coupled to surrounding frame 110. In an example embodiment as shown in FIG. 13, upper end 344 of inner channel portion 302 may include a flared opening 244 to allow easier insertion of non-beaded vertical edge 132 of flexible shade material 106. Flared opening 244 of inner channel portion 302 may provide a wider insertion space for flexible shade material 106, which allows for correct insertion of non-beaded vertical edge 132 into a respective side channel 230 with less initial insertion precision.

Embodiments of side channel 230, as shown in FIGS. 8-13, may be incorporated in window shade assembly 100, which also includes similar components from FIGS. 1-7 (e.g., lip 150, bottom rail 160, etc.) for aiding in re-channeling non-beaded vertical edge 132 of flexible shade material 106 into side channel 230. These similar components, as shown and described in reference to FIGS. 1-6, may function in a substantially similar fashion as described with reference to the other Figures herein. Redundant explanation of these elements has been omitted for clarity.

In the example embodiment of FIGS. 8-13, and as described similarly above in reference to FIG. 13, flared opening 244 of inner channel portion 302 may also aid in re-channeling non-beaded vertical edge 132 of flexible shade material 106. In the example embodiment as shown in FIG. 13, where a respective non-beaded vertical edge 132 is unintentionally removed from a respective side channel 230, flared opening 244 of inner channel portion 302 may provide a wider insertion space for flexible shade material 106 during re-channeling. Flared opening 244 allows less re-channeling precision when re-channeling non-beaded vertical edge 132 of flexible shade material 106 in inner channel portion 302, allowing the user to more easily re-channel flexible shade material 106 within side channels 230. Furthermore, side channels 230 may be temporarily detached from surrounding frame 110, by substantially disengaging magnets 140A, 140B, for aiding in the re-channeling of flexible shade material 106 within side channels 230.

Embodiments of side channel 230, as shown in FIGS. 8-13, may also include a variation of bottom rail 160 (FIG. 1) coupled to free edge 162 of flexible shade material 106. More specifically, in an example embodiment of side channel 230, bottom rail 160 may be configured as having a length substantially less than the width of flexible shade material 106, and bottom rail 160 may not include end members 164 (FIG. 2A). More specifically, bottom rail 160 may be configured to have a length substantially equal to the distance between side channels 230. In the example embodiment of side channel 230, bottom rail 160 may be coupled to a portion of free edge 162 of flexible shade material 106, positioned between side channels 230, whereby flexible shade material 106 may be positioned within side channel 230 without bottom rail 160 and end members 164.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A window shade assembly comprising:
a headrail including a roller core wrapped with a flexible shade material having a pair of non-beaded vertical edges;
a pair of opposed vertical side channels open in a direction facing one another and configured to be mounted to a surrounding frame, each side channel receiving a respective non-beaded vertical edge of the flexible shade material; and
wherein each side channel includes an outer channel portion coupled to the surrounding frame, and an inner channel portion coupled to the outer channel portion, and the inner channel portion configured to receive the non-beaded vertical edge of the flexible shade material.

2. The window shade assembly of claim 1, further comprising means for removably mounting each side channel to the surrounding frame.

3. The window shade assembly of claim 1, wherein the flexible shade material substantially seals against an inner channel wall of the inner channel portion.

4. The window shade assembly of claim 1, wherein the inner channel portion includes at least one retaining member to retain the inner channel portion within the outer channel portion.

5. The window shade assembly of claim 4, wherein the at least one retaining member includes at least one protrusion, extending from an exterior surface of the inner channel portion.

6. The window shade assembly of claim 5, wherein the at least one protrusion of the at least one retaining member is angled relative to the exterior surface of the inner channel portion.

7. The window shade assembly of claim 6, wherein the at least one retaining member has an angle (α) substantially between 5 degrees and 90 degrees relative to the exterior surface of the inner channel portion.

8. The window shade assembly of claim 4, wherein the outer channel portion includes at least one flange to retain the inner channel portion within the outer channel portion.

9. The window shade assembly of claim 8, wherein the at least one flange provides a catch surface for the at least one retaining member to prevent removal of the inner channel portion from the outer channel portion.

10. The window shade assembly of claim 1, wherein an inner surface of the outer channel portion includes a positioning member for laterally positioning the inner channel portion relative to the outer channel portion.

11. The window shade assembly of claim 10, wherein the positioning member extends substantially over a vertical length of the inner surface of the outer channel portion.

12. The window shade assembly of claim 1, further comprising a wrapping material substantially covering a front surface of the outer channel portion.

13. The window shade assembly of claim 12, wherein the outer channel portion includes at least one engager for coupling the wrapping material to the front surface of the outer channel portion.

14. The window shade assembly of claim 13, wherein the at least one engager is disposed adjacent the front surface of the outer channel portion.

15. The window shade assembly of claim 13, wherein the at least one engager includes at least one recess.

16. The window shade assembly of claim 15, further comprising a securing rod within the at least one recess. for engaging the wrapping material to secure the wrapping material in place.

17. The window shade assembly of claim 12, wherein the wrapping material includes a pattern thereon substantially similar to a pattern on the flexible shade material.

18. The window shade assembly of claim 1, wherein an upper end of at least one of the outer channel portion and the inner channel portion includes a flared open end through which the flexible shade material extends.

19. The window shade assembly of claim 1, further comprising:
a lip positioned at a vertical distance from an outer surface of the roller core to define a plane of the flexible shade material within the side channels; and
a bottom rail substantially coupled to a free edge of the flexible shade material;
whereby in response to at least one of the non-beaded vertical edges being at least partially removed from an inner channel portion, the lip and the bottom rail position the flexible shade material for re-channeling into the side channels upon rolling of the flexible shade material onto the roller core.

20. A window shade assembly comprising:
a headrail including a roller core wrapped with a flexible shade material having a pair of non-beaded vertical edges;
a pair of opposed vertical side channels open in a direction facing one another and configured to be mounted to a surrounding frame, each side channel receiving a respective non-beaded vertical edge of the flexible shade material,
wherein each side channel includes an outer channel portion coupled to the surrounding frame, and an inner channel portion coupled to the outer channel portion, and the inner channel portion configured to receive the non-beaded vertical edge of the flexible shade material;
a lip positioned at a vertical distance from an outer surface of the roller core to at least partially define a plane of the flexible shade material within the side channels; and
a bottom rail coupled to a free edge of the flexible shade material,
whereby in response to at least one of the non-beaded vertical edges being at least partially removed from a side channel, the lip and bottom rail position the flexible shade material for re-channeling into the side channels upon rolling of the flexible shade material onto the roller core.
